(19) United States
(12) Patent Application Publication
(10) Pub. No.: US 2017/0176163 A1
(43) Pub. Date: Jun. 22, 2017

(54) METHOD FOR DETERMINING A SURFACE PROFILE CHANGE IN A FILLING COMPOUND IN A RECESS

(71) Applicant: Airbus Defence and Space GmbH, Taufkirchen (DE)

(72) Inventors: Christian HERRLES, Riemerling (DE); Jan Roman HÖNNIGE, Amelinghausen (DE); Meinhard Meyer, Munchen (DE); Michael TREITZ, Munchen (DE)

(21) Appl. No.: 15/378,716

(22) Filed: Dec. 14, 2016

(30) Foreign Application Priority Data
Dec. 16, 2015 (DE) 102015225503.4

(51) Int. Cl. G01B 5/20; G01N 3/02; G01N 25/00; G01B 11/24

(52) U.S. Cl. CPC G01B 5/20; G01B 11/24; G01N 3/02; G01N 25/00

(57) ABSTRACT

A method for determining a surface profile change in a filling compound in a recess includes determining a first surface profile of a surface of the filling compound across the recess at an initial temperature; cooling or heating the recess comprising the filling compound to a predetermined measurement temperature; determining a second surface profile of the surface of the filling compound across the recess at the measurement temperature; and comparing the second surface profile with the first surface profile to determine the surface profile change.

### CROSS-REFERENCES TO RELATED APPLICATIONS

This application claims the benefit of the German patent application No. 102015225503.4 filed on Dec. 16, 2015, the entire disclosures of which are incorporated herein by way of reference.

### FIELD OF THE INVENTION

The present invention relates to a method for determining a surface profile change in a filling compound in a recess. In particular, the present invention deals with determining the surface profile change in filling compounds in joint transitions, joint grooves, grooves and/or general recesses in structures of aircraft or spacecraft.

### BACKGROUND OF THE INVENTION

Although it can be used in various applications for analyzing joint transitions or recesses, which have been filled with filling compound and/or smoothed, of a wide range of structures, the present invention and the set of problems on which it is based are described in greater detail in relation to applications in the field of aircraft wings. In principle, however, the present invention is also usable for determining surface profile changes in filled joint transitions, joint grooves or grooves in general vehicles, such as road vehicles, railway vehicles and/or water vehicles or the like.

A central requirement of modern aircraft construction is the configuration of efficient aircraft which have as low a fuel consumption and associated pollutant emission as possible. For this purpose, there is intensive research as to how improved wings can contribute to environmentally friendlier air traffic. Thus, in particular, the flow resistance of an aircraft is quite decisively influenced by the specific, speed-dependent flow progression of the air over the surfaces of the aircraft airfoils. The more uniformly this flow progresses, the lower the resistance. A low air resistance, in turn, reduces the fuel consumption, the emission of pollutants and thus also the energy costs. One approach thus involves optimizing wing constructions to the effect that a uniform, in other words laminar, flow can be maintained in the long term without the occurrence of turbulence, which would lead to an increased air resistance again.

For this purpose, it is advantageous to configure the surfaces of the airfoils and, in particular, the wing faces directed in the direction of flight, as smoothly as possible. Even very slight bumps on the surfaces due to dirt, assembly inaccuracies and/or painting inaccuracies can influence a laminar flow on the wing. Approaches for laminar wings have a rigid leading wing edge which is rigidly connected to a wing box. When a leading wing edge of this type is connected to the wing box, this results in a joint transition, which should be filled as evenly as possible with a filling compound so as to meet suitable requirements to maintain a laminar flow.

Generally, for assembling aircraft components in an exact fit, auxiliary substances such as filling compounds (for smoothing transitions or grooves), surface compensation compounds (known as shimming compounds) and adhesive layers are applied very precisely as regards the thickness thereof. Typically, these assembly processes are carried out at room temperature or higher temperatures. However, under normal cruising conditions for passenger aircraft, ambient temperatures well below −50° C. are reached, and so considerable thermal shrinkage of the auxiliary substances is sometimes to be expected. However, unawareness of or failure to take into account this type of thermal shrinkage during assembly can lead to bumps on the surfaces of the aircraft components, for example the wing surfaces, which can, in turn, influence the flow behavior of the aircraft at cruising altitude.

Further, in particular, joint transitions on the outer wing skin are subject to mechanical forces which can compress and/or expand the filling compounds in the relevant transitions or grooves, in other words, in particular, including shrinking them, and can thus bring about rearrangements of the volume. The surface profile change behavior of the filling compounds is dependent on the cross section, in other words the geometry, of the filled grooves. There is thus a need for testing methods approximating application and operation which can characterize a thermally and/or mechanically induced surface profile change over a relatively wide temperature range for advanced degrees of hardening of the filling compounds.

For example, the linear thermal expansion of a sample as a function of temperature can be analyzed using dilatometric measurements, and from this a longitudinal expansion coefficient of a filling compound sample can be obtained. However, for complex groove geometries, it is possible to draw only insufficient conclusions as to the volume change in the sample. In principle, an initial filling compound profile can be determined at room temperature. Together with the measured longitudinal expansion coefficient, in principle the thermal shrinkage can indeed be simulated on this basis. However, for this purpose assumptions have to be made as regards the geometry of the joint groove, it only being possible to take complex interactions into account to a limited extent.

### SUMMARY OF THE INVENTION

One of the aspects of the present invention is to find solutions for determining a surface profile change of filling compounds which makes possible precise yet simple determination of the surface profile change even at low temperatures.

Accordingly, a method for determining a surface profile change of a filling compound in a recess is provided. The method comprises determining a first surface profile of a surface of the filling compound across the recess at an initial temperature. The method further comprises cooling or heating the recess comprising the filling compound to a predetermined measurement temperature. The method further comprises determining a second surface profile of the surface of the filling compound across the recess at the measurement temperature. The method further comprises comparing the second surface profile with the first surface profile to determine the surface profile change.

Further, a use of the method according to the invention for determining a surface profile change in a filling compound in a recess in a structure and/or between structures, in particular wing structures, of an aircraft or spacecraft is provided.

One of the ideas behind the present invention is to determine a surface profile change in the filling compound or a deviation of the filling compound from a required smoothness or a required profile progression directly at the relevant recess filled with filling compound for different temperatures. The general concept of the recess within the meaning of the invention comprises inter alia joint transitions, joint grooves and/or grooves between joining partners or joining components and/or similar surface bumps to be filled or smoothed (for example smoothing out dents, sagging of a wing skin in the region of stringers using smoothing compound or during repairs). Further, however, a recess within the meaning of the invention also comprises general depressions in components.

For this purpose, it is possible to travel in a line along the surface profile of the surface of the recess, for example using a diamond needle of a tactile measuring instrument or using a laser of an optical measuring device (in principle surface measurements are also possible in this way). For example, a surface profile height of the surface relative to a reference surface or reference height, for example a lateral rim of the recess, can be measured as a function of a measurement position transverse to the recess. The surface profile as a function of temperature obtained from this is directly relates to the surface profile change behavior of the filling compound in the recess. Comparing the surface profiles at different temperatures makes possible direct conclusions as to the surface profile change (with respect to the reference surface or reference height). For example, for this purpose a difference between two surface profiles may be taken and the result may be used as a measure of the surface profile change. In another example, a gradient or higher derivatives of the surface profiles in relation to the measurement position with respect to temperature may also be determined. Further, however, the surface profiles thus obtained may also be analyzed by more complex methods so as to determine more detailed information as to the surface profile change as a function of location and/or temperature and/or other parameters or variables. The method according to the invention is applicable in particular to cryogenic temperatures, in other words for example, the temperatures of liquid nitrogen or the like.

Depending on the application, it may be sufficient merely to record a surface profile of the surface at two different temperatures. In principle, measurements of this type can be carried out at any desired frequency and at a number of different temperatures, so as to obtain a detailed picture of the surface profile change behavior of a filling compound in a particular recess geometry. The measurements may advantageously be taken at the same position or point in a longitudinal direction of the joint transition or recess transverse to the groove (although in principle directions other than the transverse direction are also possible, in particular including at a particular angle to the longitudinal groove direction). In principle, however, it is also provided to take measurements at different positions in the longitudinal direction of the joint transition. Repeated measurements may further be provided at the same and/or different temperatures, so as to obtain a surface profile change as a function of time. Further, by means of measurements of this type, different filling materials and/or different groove geometries can be compared with one another in a simple manner. In the case of the present invention, the surface profile change is measured directly and without any approximations or assumptions, unlike for example in the case of one-dimensional, dilatometric measurements of the longitudinal contraction, in which additional simulations, based on possibly imprecise assumptions, are required. Thus, using the solution according to the invention, the shrinkage behavior even of complex groove geometries can be analyzed in a realistic and precise manner A wide range of materials may be used both as filling materials and as joining partners/joining components.

Filling compounds within the meaning of the invention also comprise, inter alia, glues, compensation compounds (shimming compounds), coating agents, paints or filler layers or similar materials, such as filling compounds filled with metal particles and/or ceramics particles. The joining partners may comprise plastics material, metal and/or ceramics or a material composite thereof. Further, the joint transition may, for example, be a connection produced by friction stir welding or a riveted joint transition (for example, measuring over rivet heads so as to obtain thermal effects). The method according to the invention has advantages, in particular, in or on joint regions or wherever surface roughness or ripples or other bumps are to be smoothed in a defined manner using materials of this type or the like. In the event of a change in temperature, as a result of aging and/or under mechanical loads, a surface profile change (shrinkage or compression) in these surfaces treated or produced in this manner may occur, and this may result in deviations from a required smoothness.

Advantageous embodiments and developments may be derived from the additional dependent claims and from the description with reference to the drawings.

In a development, the first surface profile and/or the second surface profile may be determined by tactile profile measurement and/or optical profile measurement. For example, it is possible to travel along the surface of the filling compound using a diamond needle, in such a way that the needle tip comes into contact with the surface directly. From the vertical shift in position of the needle tip, the surface profile of the filling compound can subsequently be derived. The measuring instruments used in this case are also referred to as tactile, in other words contact-based, profilometers. Alternatively or additionally, however, optical measurement methods and in particular contactless methods may also be used, such as laser-based methods, confocal technology, white light interferometry and similar methods known to a person skilled in the art for creating a surface profile of a surface progression. For example, it is possible to travel along or scan the surface using a laser, for example within the meaning of a laser scanner or line scanner. For example, using optical sensors, the progression of a surface or the structuring of a surface can be derived from the (de)focusing of a laser beam, for example by laser profilometry.

In a development, the first surface profile and/or the second surface profile can be determined under a mechanical tensile stress, compressive stress and/or shear stress load on the recess. A mechanical torsional and/or flexural load on the recess filled with filling compound is possible. Thus, as well as the thermal surface profile change, in this development findings as to the mechanically induced surface profile change in the filling compound in the recess can also be made, and thus, in particular, predictions can be made as to how particular groove geometries comprising particular filling materials behave under predetermined mechanical loads. This includes, in particular, viscoelastic behavior, in other words, creep. In particular, the influence of mechanical loads, for example pulling apart or compression of the joining partners/joining components, on the surface profile change behavior of the filling compounds can thus be determined. Thus, using the present method, predictions can be made as to the expected behavior of particular groove geometries and filling materials under realistic use conditions as regards thermal load and mechanical loads of any type.

In a development, the method may comprise filling the recess with the filling compound. In principle, the recess may be filled, for example, by an extrusion method and/or an injection molding method. The method may further comprise partially or completely curing the filling compound in the recess, in such a way that the filling compound can have sufficient hardness in accordance with the application. In a development, filling the recess with the filling compound may comprise smoothing the surface of the filling compound. This step accordingly ensures that the surface of the filling compound prior to application of a mechanical load or change in temperature is precisely known, in such a way that surface profiles obtained in subsequent steps can be monitored as well as possible and precise predictions can be made. However, depending on the filling method, smoothing of the surface may also be superfluous, for example in the case of an injection molding method. Additionally, in principle, a component arrangement comprising an already filled recess may also be used directly, it being possible for the filling compound already to be partially or completely cured. For example, part of an aircraft component may be “sawn out” and analyzed for the behavior thereof at different temperatures.

In a development, the filling compound can be partially or completely cured in the recess at the initial temperature. For example, the recess may be assembled at room temperature and filled with a filling compound. Subsequently, the filling compound is initially cured before the temperature is lowered and a measurement is taken at a lower temperature. This ensures that volume changes due to chemical curing effects do not have an effect on the following measurements.

In a development, the recess comprising the filling compound may be cooled using a nitrogen cooling system, in other words cooled, for example using nitrogen or liquid nitrogen (LN2). In principle, however, any other known cooling or heating technology suitable for the purpose and for the desired temperature range may be used. In particular, liquid and/or evaporated or gaseous cooling medium and/or heating medium may be used.

In a development, the recess may be in the form of a joint transition between joining components or a depression in a component.

In a development, the recess may be formed between aluminum and/or carbon-fiber-reinforced plastics material (CFRP) joining components. In principle, however, the recess may also alternatively be formed as a depression in a component. In principle, other metals, metal alloys, ceramics and/or fiber composite materials (or plastics materials) are also provided (composites of different materials may be provided both in the component and in the filling) For example, these joining components or joining partners may correspond to structures of an aircraft or spacecraft or the surfaces thereof. For example, a recess may be formed between two aluminum and/or CFRP components mutually adjacent or positioned one on top of the other. For example, the two joining components may correspond to wing structures of an aircraft, which may be formed from a metal, a metal alloy and/or a fiber composite material.

In a development, a mechanical tensile stress, compressive stress and/or shear stress load on the recess (and thus the filling compound) may be established by screw-biasing the joining components. A mechanical torsional and/or flexural load on the recess filled with filling compound is possible. The screw biasing may be displacement-controlled or force-controlled (strain gauge). For example, one of the joining components between which the recess is formed may be clamped in a manner adjustable by means of a screw, in such a way that the joining component can be loaded transverse to the recess so as to generate a tensile stress or compressive stress on the recess. In this case, the mechanical load can be varied and adjusted in a particularly simple manner by simply adjusting a screw, for example a thumb screw. Alternatively or additionally, however, other mechanical, electrical or electromechanical solutions known to a person skilled in the art may also be used, such as piezo motors, stepper motors or the like. Likewise, mechanical loads can be generated by hydraulic and/or pneumatic devices. The change in length of the moved joining partners can additionally be detected by the (tactile) measurement.

In a development, the joining components having the recess positioned between them or the component comprising the recess can be placed in a cooling plate. This makes the present method or the measurement setup for a method according to the present invention particularly simple. The cooling plate can thus be cooled down or heated up to the desired temperature in a simple manner, the temperature of the recess or of the joining components automatically being adjusted accordingly as a result (at a particular temperature gradient). At the same time, a device for generating a mechanical load can also be installed on the cooling plate, in such a way that the temperature of the cooling plate ultimately regulates the temperature of the measurement setup.

In a development, a cooling liquid and/or a cooled gas, in particular nitrogen, can be passed through the cooling plate to cool the recess. For example, for this purpose, the cooling plate may comprise a cooling lance or the like through which temperature-controlled evaporated nitrogen can be passed.

In a development, the recess can be cooled together with the joining components or together with the component. Thus, in this development, an entire component arrangement can be cooled together with the recess filled with filling compound and located therein. As a result, it is possible to analyze the behavior of an entire component comprising filling compound under realistic conditions.

In a development, a screw-tensioning device for mechanically loading the joining components may be integrated into the cooling plate. The screw-tensioning device can be cooled simultaneously. In this development, a measurement setup can be integrated into the cooling plate in a particularly compact and practical manner.

The above embodiments and developments may be combined with one another in any desired manner within reason. Further possible embodiments, developments and implementations of the invention also include combinations not explicitly mentioned of features of the invention described above or in the following in relation to the embodiments. In particular, a person skilled in the art will also add individual aspects to each basic form of the present invention as improvements or additions.

### BRIEF DESCRIPTION OF THE DRAWINGS

The present invention is described in greater detail in the following by way of the embodiments set out in the schematic drawings, in which:

FIGS. 1a, 1b, 1c are schematic cross-sectional views and perspective views of joining components having a recess formed in between for use in a method according to the invention in accordance with an embodiment of the invention;

FIG. 2 is a schematic perspective view of a cooling plate, having joining components in accordance with FIG. 1 integrated into it, for use in a method according to the invention in accordance with a further embodiment of the invention;

FIG. 3 is a schematic view of a measurement setup comprising the cooling plate of FIG. 2 for use in a method according to the invention in accordance with a further embodiment of the invention;

FIG. 4 is a schematic flow chart of a method according to the invention in accordance with a further embodiment of the invention using the measurement setup in FIG. 3;

FIG. 5 is a schematic cross-sectional view of joining components comprising a recess filled with filling compound and measurement results for a surface profile change in the filling compound in the recess using a method according to FIG. 4; and

FIG. 6 is a schematic cross-sectional view of joining components comprising a recess filled with filling compound and measurement results of a surface profile change in the filling compound in the recess using an alternative method according to FIG. 4.

The accompanying drawings are intended to provide a further understanding of the embodiments of the invention. They illustrate embodiments and are intended to explain principles and concepts of the invention in connection with the description. Other embodiments and many of the stated advantages can be seen from the drawings. The elements of the drawings are not necessarily to scale.

In the drawings, unless specified otherwise, like, functionally equivalent and equivalently acting elements, features and components are provided with like reference numerals.

### DETAILED DESCRIPTION OF THE PREFERRED EMBODIMENTS

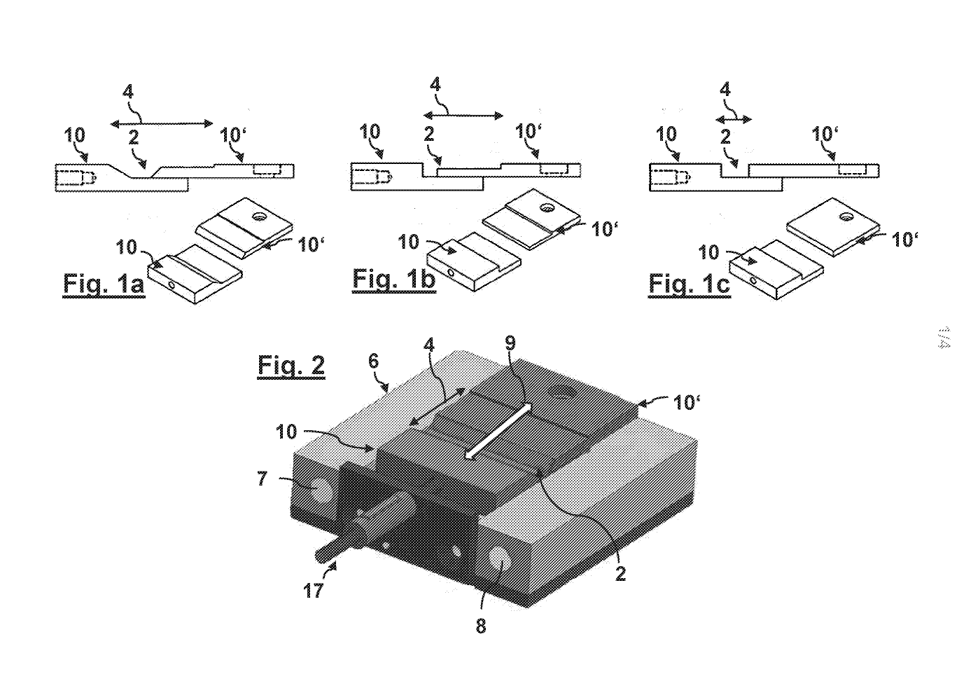

FIGS. 1a, 1b, 1c are schematic cross-sectional views and perspective views of joining components having a recess formed in between for use in a method according to the invention in accordance with an embodiment of the invention.

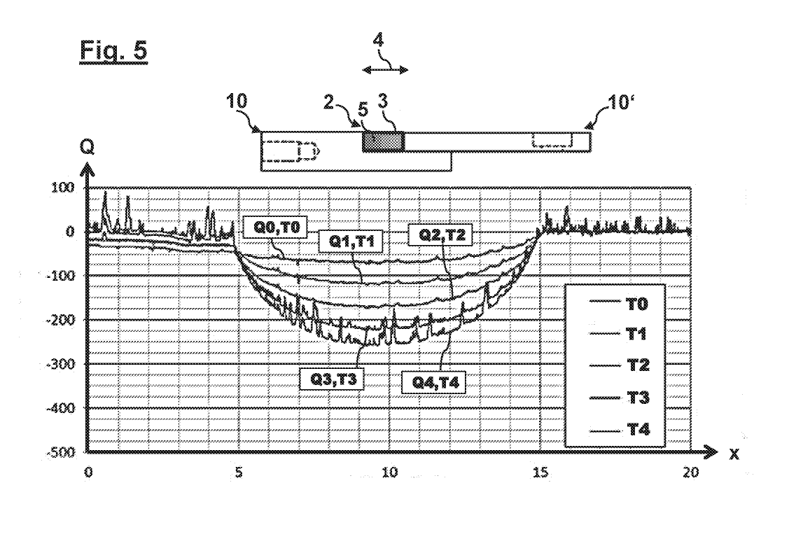

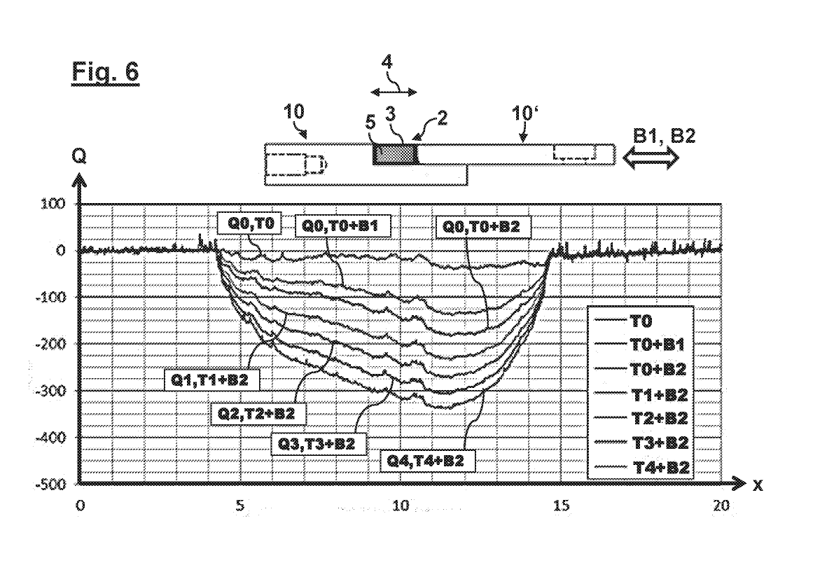

In FIGS. 1a, 1b, 1c, reference numerals 10 and 10′ each denote a joining component. The two joining components 10, 10′ may be placed against one another as shown in the drawings, causing a joint transition or a recess 2 of a particular groove width 4 to be formed between them. In principle, the two joining components 10, 10′ or joining partners may be any desired components or structures. In principle, moreover, various materials are provided for the joining components 10, 10′. For example, they may be formed from a metal, a metal alloy or a composite material, for example a fiber composite material. In particular, the joining components 10, 10′ may comprise aluminum and/or fiber-reinforced plastics material, for example carbon-fiber-reinforced plastics material (CFRP). The joining components 10, 10′ may, for example, correspond to portions of structures or surfaces of an aircraft or spacecraft. For example, they may be wing structures or wing surface portions of a laminar aircraft wing, it being possible for a joining component 10 to correspond, for example, to a portion of a rigid leading wing edge which is rigidly connected to a second wing structure, for example a wing box, which is the other joining component 10′. When a leading wing edge of this type is attached to the wing box, this may result in a recess 2, such as is shown schematically in FIGS. 1a, 1b, 1c. So as to meet suitable requirements for maintaining a laminar flow, a recess 2 of this type should be filled with a filling compound 5 as precisely as possible (cf. FIGS. 5 and 6). At the same time, the behavior of the filling compound in the recess 2 under mechanical and/or thermal influences should be known and monitored. Thus, a thermal surface profile change in the filling compound 5, which has been filled into a recess 2 at room temperature and cured therein, is expected at the usual ambient temperatures of passenger aircraft of less than −50° C. Ignoring a thermal surface profile change of this type during assembly can result in bumps in the surfaces of the aircraft components, for example the wing surface, which can in turn influence the flow behavior of the aircraft at cruising altitude. Further, during operation of the aircraft, filled recesses of this type are subject to mechanical loads which may also have an influence on the surface profile change in the filling compound 5. The methods described in detail in connection with the following drawings make it possible to determine a surface profile change in filling compounds 5 in a manner which can be implemented even at low temperatures without complications or loss of precision. It will be clear to a person skilled in the art that the joining components 10, 10′ and recesses 2 shown in FIG. 1a, 1b, 1c are purely exemplary in nature, and are merely intended to illustrate the underlying principles of the invention. Numerous other component geometries can readily be measured by the method according to the invention.

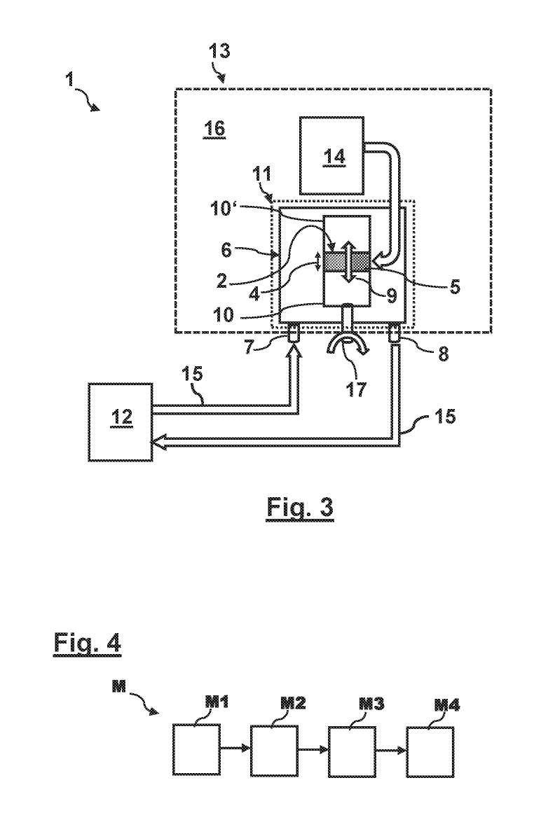

FIG. 2 is a schematic perspective view of a cooling plate 6 having joining components 10, 10′ integrated into it in accordance with FIG. 1a for use in a method according to the invention in accordance with a further embodiment of the invention. For this purpose, the cooling plate 6 may be provided with a receptacle into which each of the two joining components 10, 10′ can be inserted (shown in FIG. 2). In the example embodiment of FIG. 2, the geometries of the joining components 10, 10′ and of the recess 2 formed between them correspond to the embodiment of FIG. 1a. At least one joining component 10 of the two joining components 10, 10′ is held against the other joining component 10′ by a screw-tensioning device 17. By adjusting the screw-tensioning device 17, a mechanical tensile or compressive load on the recess 2 and a filling component 5 introduced into it can be adjusted, as will be explained in greater detail below. The cooling plate 6 is connected to a nitrogen cooling system 12 (cf. FIG. 3), for example based on cryo-evaporated nitrogen, by means of which temperature-controlled nitrogen 15 can be passed through the cooling plate 6 as a gas to cool it and the joining components 10, 10′ located thereon as well as the filling compound 5 in the recess 2. For this purpose, the cooling plate 6 comprises a cooling medium inlet 7 and a cooling medium outlet 8. In principle, as well as nitrogen, other suitable liquid and/or evaporated or gaseous cooling media and/or heating media may also be used.

FIG. 3 is a schematic view of a measurement setup 1 comprising the cooling plate 6 of FIG. 2 for use in a method according to the invention in accordance with a further embodiment of the invention. In FIG. 3, as in FIG. 2, two joining components 10, 10′ have been inserted into the cooling plate 6 so as to form a recess 2 having a groove width 4 between them. In FIG. 3, the recess 2 is shown with a filling compound 5 located therein. In this example measurement setup 1, the cooling plate 6 has been compactly thermally insulated by packing it into an insulating material 11, with the exception of a small strip-shaped measurement region 9 which remains exposed. For example, the insulating material 11 may be a polystyrene rigid foam or another suitable insulant. The measurement region 9 is accessible to a profilometer 14, which may for example be a tactile profile measuring instrument. The profilometer 14 may thus be formed to scan and measure a surface profile of the filling compound 5 in the recess 2 using a diamond needle (not shown). For this purpose, the diamond needle may travel along the strip-shaped measurement region 9. The precise sequence of a measurement method of this type is described below in connection with FIG. 4.

As is shown in FIG. 2, the cooling plate 6 is formed with a cooling medium inlet 7 and a cooling medium outlet 8, through which nitrogen 15 can be passed continuously by means of a nitrogen cooling system 12 so as to cool the cooling plate 6 together with the joining components 10, 10 located thereon and the recess 2 filled with filling compound 5. To prevent the formation of ice crystals along the measurement region 9, in the example measurement setup 1 of FIG. 3 the cooling plate 6 along with the insulation has further been enclosed in a box 13, which is filled with a dry gas, for example temperature-controlled nitrogen 16 or argon, for example below room temperature.

FIG. 4 is a schematic flow chart of a method M according to the invention in accordance with a further embodiment of the invention using the measurement setup 1 of FIG. 3. The method M is used to determine a surface profile change in the filling compound 5 in the recess 2. For this purpose, the method M may comprise filling the recess 2 with the filling compound 5 and partially or completely curing the filling compound 5 in the recess 2. For example, the filling compound 5 may be filled into the recess 2 at an initial temperature T0 and also cured in the recess 2 at this temperature. For example, the initial temperature T0 may correspond to a typical room temperature; for example, it may be that T0=23° C. Further, filling the recess 2 at M1 may additionally include smoothing a surface 3 of the filling compound 5 in the recess 2. In principle, however, a component arrangement comprising an already filled recess 2 may also be used directly, it being possible for the filling compound 5 already to be partially or completely cured.

At M1, the method M subsequently comprises determining a first surface profile Q0 of the surface 3 of the filling compound 5 transversely across the recess 2 at the initial temperature T0. Subsequently, at M2, the method M comprises cooling or heating the recess 2 comprising the filling compound 5 to a predetermined measurement temperature T1, T2, T3, T4. Subsequently, at M3, the method M comprises determining a second surface profile Q1, Q2, Q3, Q4 of the surface 3 of the filling compound 5 transversely across the recess 2 at the measurement temperature T1, T2, T3, T4. Further, at M4, the method M comprises comparing the second surface profile Q1, Q2, Q3, Q4 with the first surface profile Q0 to determine the surface profile change. Both the first surface profile Q0 and the second surface profile Q1, Q2, Q3, Q4 may be measured under a mechanical load B1, B2 on the recess 2 using a tensile stress or a compressive stress. For this purpose, the screw-tensioning device 17 may generate a tensile or compressive stress on the joining components 10, 10′ and the recess 2 filled with filling compound 5 as a result of adjustment of a corresponding screw. The surface profiles Q0, Q1, Q2, Q3, Q4 are each measured by the tactile profilometer 14 in that it scans the surface 3 of the recess 2 along the measurement region 9 transverse to the recess 2 using a diamond needle.

In principle, the method may measure many different second surface profiles Q1, Q2, Q3, Q4 at different measurement temperatures T1, T2, T3, T4. For this purpose, the steps of cooling or heating at M2 and measuring at M3 may be carried out a plurality of times in succession. For example, the initial temperature T0 may correspond to a room temperature, for example T0=23° C., and the surface profile change in the filling compound 5 in the recess 2 may be measured for four different measurement temperatures T1, T2, T3, T4, for example T1=0° C., T2=−20° C., T3=−40° C. and T4=−55° C. Accordingly, for each measurement temperature T1, T2, T3, T4 this results in an associated second surface profile Q1, Q2, Q3, Q4: (Q1, T1), (Q2, T2), (Q3, T3), (Q4, T4) and (Q5, T5).

FIG. 5 is a schematic cross-sectional view of joining components 10, 10′ comprising a recess 2 filled with filling compound 5 and measurement results for a surface profile change in the filling compound 5 in the recess 3, which were obtained using a method according to FIG. 4. Therein, the first surface profile Q0 for the initial temperature T0 and the second surface profiles Q1, Q2, Q3, Q4 for four measurement temperatures are plotted by way of example. Each surface profile Q is shown as a function of the measurement position x along the strip-shaped measurement region 9 along the surface 3 of the recess 2. As expected, a clear (symmetrical) surface profile change in the filling compound 5 towards colder temperatures can be seen.

FIG. 6 is a schematic cross-sectional view of joining components 10, 10′ comprising a recess 2 filled with filling compound 5 and measurement results for a surface profile change in the filling compound 5 in the recess 2 using an alternative method M according to FIG. 4. Unlike in FIG. 5, in this example the first surface profile Q0 was also measured under two example mechanical loads B1, B2. For this purpose, the screw-tensioning device 17 was adjusted accordingly so as to produce a tensile or compressive stress on the joining components 10, 10′ and the recess 2 (see arrow top of FIG. 6). Accordingly, this results in a first surface profile Q0 for the initial temperature T0 without a mechanical load (Q0, T0), as well as two further first surface profiles Q0 for the initial temperature T0 at a different mechanical load B1, B2 in each case: (Q0, T0+B1) and (Q0, T0+B2). It can clearly be seen that, unlike in FIG. 5, an asymmetrical surface profile change occurs in the filling compound 5 in the recess 2. Accordingly, four different second surface profiles Q1, Q2, Q3, Q4 for four different measurement temperatures T1, T2, T3, T4 are further plotted in FIG. 6, a particular mechanical load B2 having been set in each case. As in FIG. 5, in this case too, the surface profile change is greater for falling measurement temperatures T1, T2, T3, T4, although the asymmetry in the mechanical load B2 is maintained in all cases.

In the above detailed description, various features have been combined in one or more examples to improve the conciseness of the explanation. However, it should be clear that the above description is merely illustrative and not limiting in nature. It serves to cover all alternatives, modifications and equivalents of the various features and embodiments. Many other examples will be immediately and directly clear to the person skilled in the art from the above description on the basis of his expert knowledge.

The embodiments are selected and described so as to be able to explain the principles behind the invention and the possible practical applications thereof as clearly as possible. As a result, persons skilled in the art can modify and use the invention and the various embodiments thereof optimally for the intended purpose of use. In the claims and description, the terms “containing” and “having” are used as neutral concepts for the corresponding term “comprising”. Further, use of the terms “a” and “an” does not in principle exclude the possibility of a plurality of features and components described in this manner.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for determining a surface profile change in a filling compound in a recess, comprising:
determining a first surface profile of a surface of the filling compound across the recess at an initial temperature;
cooling or heating the recess comprising the filling compound to a predetermined measurement temperature;
determining a second surface profile of the surface of the filling compound across the recess at the measurement temperature; and
comparing the second surface profile with the first surface profile to determine the surface profile change.

2. The method of claim 1, wherein at least one of the first surface profile or the second surface profile is determined by at least one of a tactile profile measurement or an optical profile measurement.

3. The method of claim 1, wherein at least one of the first surface profile or the second surface profile is determined under at least one of a mechanical tensile stress, compressive stress or shear stress load on the recess.

4. The method of claim 1, wherein the recess comprising the filling compound is cooled using a nitrogen cooling system.

5. The method of claim 1, wherein the recess is in the form of one of a joint transition between joining components or a depression in a component.

6. The method of claim 5, wherein the recess is formed between at least one of aluminum or carbon-fiber-reinforced plastics material joining components.

7. The method of claim 5, wherein at least one of a mechanical tensile stress, compressive stress or shear stress load on the recess is established by screw-biasing the joining components.

8. The method of claim 5, wherein one of:
the joining components having the recess positioned between them, or
the component comprising the recess,
are placed in a cooling plate.

9. The method of claim 8, wherein at least one of a cooling liquid or a cooled gas are passed through the cooling plate to cool the recess.

10. The method of claim 9, wherein the at least one of a cooling liquid or a cooled gas is nitrogen.

11. The method of claim 8, wherein the recess is cooled together with the one of the joining components or together with the component.

12. The method of claim 11, wherein a screw-tensioning device for mechanically loading the joining components is integrated into the cooling plate, and the screw-tensioning device is cooled simultaneously.
